(19) United States
(12) Patent Application Publication
(10) Pub. No.: US 2008/0161050 A1
(43) Pub. Date: Jul. 3, 2008

(54) Method for configuring a wireless communication device to operate in a wireless communication system through automatic SIM pairing and associated wireless communication device

(76) Inventors: Jeffrey B. Shudark, Cumming, GA (US); Salman I. Bhatti, Coral Springs, FL (US); Sherry Easter Dubin, Orlando, FL (US); David R. Heeschen, Coral Springs, FL (US)

Correspondence Address: BRINKLEY, MORGAN, SOLOMON, TATUM, etal., 200 E. LAS OLAS BLVD., SUITE 1900, FORT LAUDERDALE, FL, 33301, US

(21) Appl. No.: 11/647,846

(22) Filed: Dec. 29, 2006

(51) Int. Cl. H04M 1/00

(52) U.S. Cl. 455/558

(57) ABSTRACT

A wireless communication device performs a method for automatically configuring itself to operate in a wireless communication system managed by a system controller. The wireless device includes an internal memory device containing a first memory identifier associated with a first removable memory device and a first user identifier associated with a user of the wireless device. In one embodiment, the wireless device compares the first memory identifier with a second memory identifier stored in a removable memory device coupled to the wireless device, and transmits a registration message including the second memory identifier to the system controller if the first memory identifier is different than the second memory identifier. The wireless device receives a registration confirmation message including a second user identifier associated with an expected user, and stores the second memory identifier in the internal memory device if the second user identifier matches the first user identifier.

### FIELD OF THE INVENTION

The present invention relates generally to the field of wireless communication systems and, more particularly, to a method and apparatus for automatically configuring a wireless communication device to operate in a wireless communication system by pairing of a SIM card to be used with the wireless communication device.

### BACKGROUND OF THE INVENTION

As the use of cellular and other wireless telephone communications has become increasingly widespread, the number of competing communication protocols and service providers has grown tremendously. In the past, a typical service provider generally maintained a network that operated using a single protocol (e.g., the code division multiple access (CDMA) 2000 1X protocol, the Global System for Mobile Communications (GSM) protocol, or Motorola's iDEN® protocol). Therefore, to function properly within the network, each cellular phone only had to support the single operating protocol. However, with the passage of time, many new protocols have been introduced. Additionally, several service providers have merged with, or otherwise acquired, competing services. As a result, many service providers now offer cellular coverage over networks encompassing multiple protocols.

To obtain an optimal performance on these combined networks, many cellular phones are designed to have multi-mode operation. For instance, at least one company has offered phones using the combination of GSM and CDMA2000 1X protocols for quite some time. However, because most protocols are not designed to work in conjunction with competing protocols, the integration of different protocols into one phone is not necessarily seamless. For example, the CDMA2000 1x protocol and Motorola's iDEN protocol have contrasting methods of assigning a network identity or identification (ID) to a subscriber.

CDMA systems were designed with a single end-user in mind. Each subscriber is intended to possess and carry a single phone. Thus, in a CDMA system, the subscriber ID (typically, although not always, referred to as an International Mobile Subscriber Identity (IMSI)) is associated with the phone hardware and is embedded within the actual CDMA chipset of the phone. The CDMA account is tied to the actual phone, not the user. If a user wishes to change or upgrade phones, he/she must call the network operator and request that the account be changed to another phone. The switch is then made at the service provider and another IMSI or similar ID is associated with the user.

In contrast to CDMA systems, Motorola's iDEN system and GSM systems were designed to, among other things, fill the needs of a business or service fleet, as in the case of the iDEN system, or simply provide users flexibility when selecting and changing phones, as in the case of GSM. Because the iDEN system incorporates the capabilities of a two-way radio with those of a cellular phone, the iDEN protocol has been a natural choice for the service industry. However, the subscriber ID is not tied to a single phone in an iDEN system or a GSM system. Instead, the subscriber ID, which may be an IMSI or other appropriate ID, is stored within a Subscriber Identity Module (SIM) card that can be easily transferred between phones. The SIM card also includes its own unique ID (typically referred to as a “SIM ID”), which is associated with the iDEN or GSM IMSI at the time the phone is provisioned in the iDEN or GSM system, as applicable. When a user wishes to change phones, all that is required is that the SIM card be removed from the old phone and inserted into the new phone. Upon power-up, the only information sent to the network is contained on the SIM card. Because most businesses or service fleets depend upon their employees having reliable phones at all time, this feature allows the businesses to stock spare phones to have on hand in the event that something happens to an employee's phone. In such case, the employee merely inserts his/her old SIM card in the new phone and is ready to talk immediately.

A problem arises when the CDMA protocol and either of the iDEN protocol or the GSM protocol are deployed in the same phone. Each protocol needs a subscriber ID in a corresponding format; therefore, there are two subscriber IDs for each phone (e.g., one IMSI for the CDMA protocol and another IMSI for the iDEN protocol or the GSM protocol). However, because the iDEN or GSM ID is stored in the SIM card and the CDMA ID is stored in the phone, the two ID parts of the user's account are not linked together. So, if a user of a dual-mode CDMA/iDEN or CDMA/GSM phone attempts to exchange SIM cards with another phone, as existing iDEN and GSM phones allow, the user's account will be split into two distinct parts. The original handset will maintain the CDMA account, but the iDEN or GSM account remains with the SIM card and can be accessed using another phone. This scenario is particularly troublesome for service fleets having a large number of customers because there is ample opportunity to exchange SIM cards with other phones. Over time, tracking of phone usage over the CDMA network for each individual user could become virtually impossible for a business owner due to the separation between CDMA and iDEN/GSM accounts.

To address the foregoing concern regarding CDMA phone usage by multiple users of a dual mode CDMA/iDEN or CDAM/GSM phone, verification processes have been implemented in an attempt to link a particular SIM card with a specific phone and place the phone in a locked mode if the verification fails. Linking of a SIM card to a particular phone is referred to in the art as “pairing.” However, in order to use a dual-mode phone once it has failed the verification process (e.g., due to the attempted use of a SIM card in a dual-mode phone for which the SIM card has not been paired), the user must call the service provider and obtain a pass code that will unlock the phone. Generally, the phone is pre-programmed to contain a master unlock code and a one-time use unlock code. Once the one-time use unlock code has been entered successfully, it expires and cannot be re-used. After that time, if the user has additional verification or access problems, the service provider must relay the master unlock code to the user. Service providers dislike revealing the master unlock code as this can potentially make the network vulnerable to hacking or theft.

Therefore, a need exists for, among other things, a method and apparatus for configuring a wireless communication device desired to be used by a user in possession of a SIM card to operate in a wireless communication system by automatically pairing the SIM card to the wireless communication device, to overcome the shortcomings of the prior art.

### SUMMARY

Generally, the present invention encompasses a wireless communication device and a method for automatically configuring the wireless communication device to operate in a wireless communication system that includes a system controller for managing access to the wireless communication system. In accordance with one embodiment, the wireless communication device includes an internal memory device that is operable, on a one-by-one basis, with several different removable memory devices. A first memory identifier (e.g., a SIM ID or other appropriate identifier) associated with a first removable memory device (e.g., a SIM card or other insertable or attachable memory device) and a first user identifier (e.g., an IMSI or other appropriate identifier) associated with a user of the wireless communication device are stored in the internal memory device.

At power-up or any other appropriate time, the wireless communication device compares the first memory identifier with a second memory identifier stored in a removable memory device coupled to the wireless communication device. The removable memory device may be the first removable memory device or a different removable memory device. In the event the first memory identifier is different than the second memory identifier (i.e., the removable memory device coupled to the wireless devices is not the removable memory device corresponding to the memory identifier stored in the wireless device's internal memory), the wireless communication device enters a restricted operating mode and transmits a registration message that includes the second memory identifier to the system controller. Responsive to the registration message, the wireless communication device receives a registration confirmation message from the system controller which includes a second user identifier associated with an expected user of the wireless communication device. The wireless communication device compares the second user identifier with the first user identifier and, in the event that the second user identifier matches the first user identifier, ceases operating in the restricted operating mode and enters a normal operating mode. In one embodiment, the wireless communication device enters the restricted operating mode upon determining that the removable memory device is not the first removable memory device. In another embodiment, the wireless communication device may continue operating in the restricted mode even though the second user identifier is different than the first user identifier.

In an alternative embodiment, the wireless communication device stores the second memory identifier in the internal memory in the event that the second user identifier matches the first user identifier. The second memory identifier may be stored separately or in place of the first memory identifier.

In another embodiment, a wireless communication device compares a first memory identifier associated with a first removable memory device to a second memory identifier stored in a removable memory device coupled to the wireless communication device. The removable memory device may be the first removable memory device or a different removable memory device. The wireless communication device then determines whether the removable memory device contains a user identifier and, if it doesn't, transmits a registration message that includes the first memory identifier to the system controller. After receiving a registration confirmation message from the system controller that includes a second user identifier associated with an expected user of the wireless communication device, the wireless communication device stores the second user identifier in the internal memory and in the removable memory device. The second user identifier may be stored separately or in place of the first user identifier in the internal memory of the wireless communication device.

In another alternative embodiment, a wireless communication device compares a first memory identifier associated with a first removable memory device to a second memory identifier stored in a removable memory device coupled to the wireless communication device. The removable memory device may be the first removable memory device or a different removable memory device. In the event that the first memory identifier does not match the second memory identifier, the wireless communication device enters a restricted operating mode and, in response to further determining that the removable memory device does not contain a user identifier, transmits a registration message to the system controller that includes the second memory identifier. Responsive to the registration message, the wireless communication device receives a registration confirmation message from the system controller that includes a user identifier, and compares the received user identifier with user identifier stored in internal memory. In the event that the received user identifier matches the stored user identifier, the wireless communication device ceases the restricted operating mode and enters a normal operating mode. In the event that the first memory identifier matches the second memory identifier, but the removable memory device does not contain a user identifier, the wireless communication device transmits a registration message to the system controller, receives a confirmation message containing a user identifier responsive thereto, and stores the received user identifier in the internal memory and in the removable memory device.

In a further embodiment, in the event that the first memory identifier matches the second memory identifier and the removable memory device includes a user identifier, the wireless communication device compares the first user identifier with the user identifier stored in the removable memory device and enters a locked operating mode in the event that the user identifier stored in the removable memory device does not match the first user identifier.

In another alternative embodiment, a wireless communication device stores in internal memory a second memory identifier stored in a removable memory device coupled to the wireless communication device in the event that a first memory identifier stored in the internal memory of the wireless communication device does not match the second memory identifier, but a second user identifier stored in the removable memory device matches a first user identifier stored in the wireless communication device's internal memory. The second memory identifier may be stored in the wireless device's internal memory separately or in place of the first memory identifier. Alternatively, in the event that the first memory identifier stored in the wireless device's internal memory matches the second memory identifier stored in the removable memory device, the second user identifier of the removable memory may be stored in the internal memory of the wireless communication device either separately or in place of the wireless device's first user identifier in the event that the first user identifier does not match the second user identifier. In this embodiment, the wireless communication device enters a normal operating mode when the first memory identifier matches the second memory identifier and the first user identifier matches the second user identifier.

### BRIEF DESCRIPTION OF THE DRAWINGS

FIG. 1 is a block diagram of a communication system incorporating a method for automatically configuring a wireless communication device to operate in the wireless communication system, in accordance with one embodiment of the present invention.

FIG. 2 is a block diagram illustrating a wireless communication device according to an exemplary embodiment of the present invention.

FIGS. 3-5 are logic flow diagrams illustrating steps executed by a wireless communication device to implement a method for automatically configuring the wireless communication device to operate a wireless communication system in accordance with exemplary embodiments of the present invention.

### DETAILED DESCRIPTION

Before describing in detail exemplary embodiments that are in accordance with the present invention, it should be observed that the embodiments reside primarily in combinations of apparatus components and processing steps related to implementing a method of automatically configuring a wireless communication device to operate in a wireless communication system. Accordingly, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms, such as “first” and “second,” “top” and “bottom,” and the like, are used solely to distinguish one entity or element from another entity or element without necessarily requiring or implying any physical or logical relationship or order between such entities or elements. The terms “comprises,” “comprising,” or any other variation thereof are intended to cover a non-exclusive inclusion, such that a process, method, article, or apparatus that comprises a list of elements does not include only those elements, but may include other elements not expressly listed or inherent to such process, method, article, or apparatus. The term “plurality of” as used in connection with any object or action means two or more of such object or action. A claim element proceeded by the article “a” or “an” does not, without more constraints, preclude the existence of additional identical elements in the process, method, article, or apparatus that includes the element.

The terms “wireless communication device,” “portable communication device,” and “mobile communication device” are used interchangeably herein and are intended to broadly cover many different types of devices that can wirelessly receive signals, and optionally can wirelessly transmit signals, and may also operate in a wireless communication system. For example, and not by way of limitation, a wireless, portable, or mobile communication device may include any one or a combination of the following: a cellular telephone, a mobile phone, a smart phone, a two-way radio, a two-way pager, a wireless messaging device, a laptop or personal computer, a personal digital assistant (PDA), a wireless email device, a portable gaming device including a built-in wireless modem, and the like.

It will be appreciated that embodiments of the invention described herein may be comprised of one or more conventional processors and unique stored program instructions that control the one or more processors to implement, in conjunction with certain non-processor circuits, some, most, or all of the functions for automatically configuring a wireless communication device to operate in a wireless communication system as described herein. The non-processor circuits may include, but are not limited to, a radio receiver, a radio transmitter, signal drivers, clock circuits, power source circuits, and user input devices. As such, these functions maybe interpreted as steps of a method to automatically configure the wireless communication device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) without undue experimentation.

Dual-mode cellular telephones are designed to operate over networks using two independent communication protocols. In an exemplary embodiment of the present invention, a dual-mode wireless communication device operates using both CDMA and iDEN protocols. Alternatively, a multi-mode wireless communication device may operate using CDMA and GSM protocols, or any other two or more protocols provided that at least one of the protocols utilizes a removable memory device, such as a SIM card, to store an identifier associated with a user of the wireless communication device in one of the protocol modes. Each protocol requires a subscriber identity configured according to the specific protocol standards. Problems arise because one subscriber identity is linked to the wireless communication device user (e.g., for the CDMA2000 1X protocol) and another subscriber identity is linked to a removable memory device, such as a SIM card (e.g., for the iDEN or GSM protocol). When the SIM card is removed from the wireless communication device and either the old card is inserted into a new wireless communication device or a new card is inserted into the old wireless communication device, the account is split, allowing communication on a single account using two separate wireless communication devices.

An embodiment of the present invention resolves this problem by automatically pairing the identity of both the removable memory device (e.g., a SIM card or any other portable memory device usable with wireless communication devices) and the actual user account with a specific wireless communication device in order to ensure that the removable memory device remains with the wireless communication device. Additionally the wireless communication device is automatically re-paired to a different removable memory device whenever the wireless communication device successfully registers with a service provider. This automatic pairing feature allows the user to change a removable memory device (e.g., in the event the removable memory device is damaged or to upgrade to a newer removable memory device) without losing personal data stored on the removable memory device. Additionally, the wireless communication device automatically re-pairs to a different user account upon successful registration with a service provider, as long as the removable memory device remains the same. This latter feature allows the wireless communication device to automatically update account numbers (e.g., in the event that the user moves to a new region, the user leaves a job where the employer paid for cellular service, etc.) without user intervention.

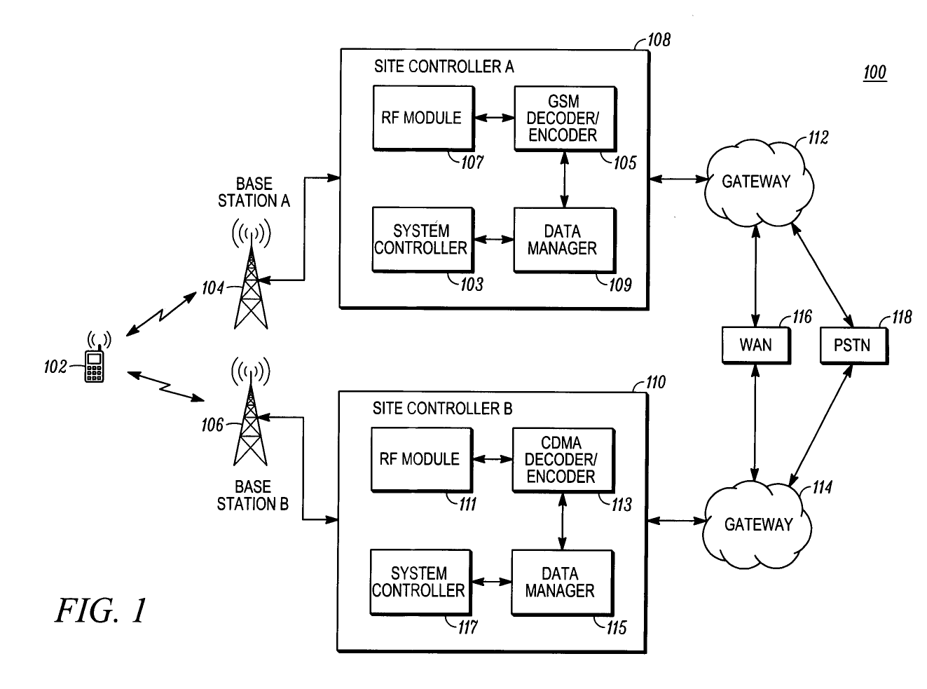

The present invention can be more readily understood with reference to FIGS. 1-5, in which like reference numerals designate like items. FIG. 1 depicts an exemplary wireless communication system 100 in accordance with one embodiment of the present invention. The exemplary wireless communication system 100 connects at least one multi-mode (e.g., dual mode) wireless communication device 102 to other wireless communication devices and/or to other networks, including wide-area networks 116 (e.g., the Internet), a public switched-telephone network 118, and the like, via a plurality of base stations 104, 106 (two shown). Each base station 104, 106 may operate using a specific communication standard or protocol, or the base station 104, 106 may contain necessary equipment to communicate using several different protocols. In the exemplary wireless communication system 100 of FIG. 1, base station “A” 104 communicates using the GSM protocol and base station “B” uses the CDMA2000 1X protocol, although various other protocol combinations may be used (e.g., CDMA2000 1X and iDEN, wideband CDMA and GSM, or wideband CDMA and iDEN). Each base station 104, 106 is managed by a site controller 108, 110 connected to other network devices via a gateway 112, 114 or other appropriate infrastructure device.

In one embodiment, the site controller 108 for base station “A” 104 contains a radio frequency (RF) module 107 which transmits and receives wireless signals containing digital information encoded according to the GSM protocol, with a carrier frequency in a range of frequencies designated by the GSM standard. RF signals received by the GSM RF module 107 are downconverted and demodulated, providing a stream of data formatted according to the GSM protocol to a GSM decoder/encoder module 105. The GSM decoder/encoder module 105 decodes the received data and a GSM data manager 109 routes the information to a destination determined according to information contained in the data. Upon power-up when the wireless communication device 102 is setup to initially operate using the GSM protocol, the wireless communication device 102 transmits a registration message requesting access to the communication system 100. The message is routed to a GSM system controller 103 which verifies the wireless communication device 102 is linked to a valid GSM account and authorizes or restricts the use of the wireless communication device 102.

The site controller 110 for base station “B” 104 contains an RF module 111 that transmits and receives wireless signals containing digital information encoded according to the CDMA protocol, with a carrier frequency within the range allocated for CDMA systems. RF signals received by the CDMA RF module 111 are downconverted and demodulated, providing a stream of data formatted according to the CDMA protocol to a CDMA decoder/encoder module 113. The CDMA decoder/encoder module 113 decodes the received data and a CDMA data manager 115 routes the information to a destination determined by the data. Upon power-up when the wireless communication device 102 is setup to initially operate using the CDMA protocol, the wireless communication device 102 transmits a CDMA system registration message requesting access to the communication system 100. The decoded message is routed to a CDMA system controller 117 which verifies that the wireless communication device 102 is linked to a valid CDMA account and authorizes or restricts the use of the wireless communication device 102. In an alternative embodiment, both base stations 104, 106, or the single base station where such base station is configured to operate using multiple protocols, may be controlled by a single site controller and, accordingly, a single system controller.

The wireless communication system 100 may comprise, inter alia, a mobile phone network, a mobile text messaging network, a paging network, a data network, or any combination thereof. The communication standards or protocols of the wireless communication system 100 may include any combination of conventional protocols or multiple access techniques, including, without limitation, CDMA, Time Division Multiple Access (TDMA), GSM, Enhanced Data GSM Environment (EDGE), iDEN, General Packet Radio Service (GPRS), Frequency Division Multiple Access (FDMA), Orthogonal Frequency Division Multiplexing (OFDM), or the like. Additionally, the wireless communication system 100 may further utilize media messaging standards, such as Short Message Service (SMS), Enhanced Messaging Service (EMS), Multimedia Messaging Service (MMS), or the like. The wireless communication system 100 may further allow for push-to-talk or dispatch over cellular communications between capable wireless communication devices.

The wireless communication system 100 supports any number of wireless communication devices 102 and/or wireline communication devices (e.g., personal or desktop computers). For example, the wireless communication system 100 of FIG. 1 supports mobile telephones, smart phones, text messaging devices, PDAs, handheld computers, pagers, beepers, wireless communication cards (e.g., those operating in accordance with the Personal Computer Memory Card International Association (PCMCIA) standard), handheld video game systems incorporating wireless access technology, or the like. A smart phone is a mobile telephone that has additional application processing capabilities. For example, a smart phone may include a combination of 1) a pocket PC, handheld PC, palm top PC, email messaging device, or PDA, and 2) a mobile telephone.

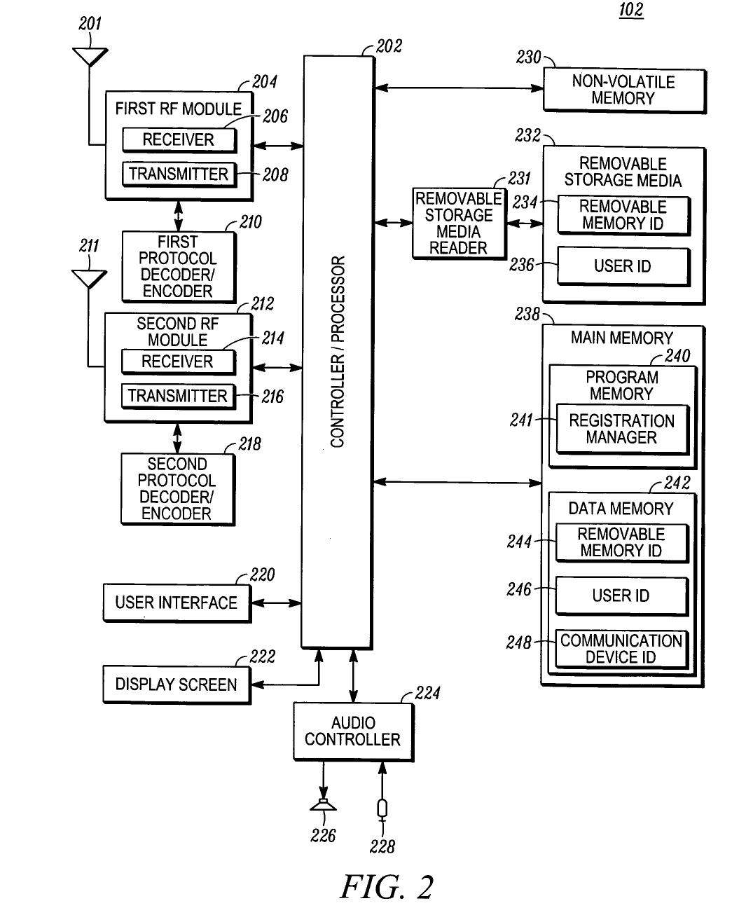

Referring now to FIG. 2, an electrical block diagram of an exemplary wireless communication device 102, according to one embodiment of the present invention, is shown in more detail. The wireless communication device 102 includes a controller/processor 202, which controls the operation of the wireless communication device 102 according to computer instructions stored in a program memory 240. The wireless communication device 102 also includes a non-volatile memory 230 and a main memory 238. A registration manager 241, which is discussed in greater detail below, is contained in the program memory 240.

In one embodiment, a removable storage media reader 231 transfers data between a removable memory device 232 (e.g., a SIM card, a memory stick, a USB flash drive, or any other portable data storage device) and the controller/processor 202. The removable memory device 232 includes a memory identifier (ID) 234 (e.g., a SIM ID or other analogous ID), which is a unique identifier permanently stored in the removable memory device 232 during manufacturing, and a user ID 236 (e.g., an IMSI or other analogous ID), which identifies the wireless communication device subscriber or user and his or her account within the communication system 100. The user ID 236 is associated with the memory ID 234 by the system controller 117 managing access to the GSM system upon the initial registration of the wireless communication device 102. The system controller 117 transmits the user ID 236 to the wireless communication device 102 for storage in the removable memory device 232. In an alternative embodiment where a single base station is configured to operate using multiple protocols, a single system controller, managing access to accounts operable using multiple protocols, associates the user ID 236 with the memory ID 234 and transmits the user ID 236 to the wireless communication device 102.

Additionally, the main memory 238, in one embodiment, includes the program memory 240 and a data memory 242. The data memory 242 contains a memory ID 244 corresponding to the last removable memory device 232 paired with the wireless communication device 102 and a user ID 246 (e.g., IMSI) corresponding to the user ID 236 stored on the last paired removable memory device 232. The data memory 242 also contains a communication device ID 248, such as an International Mobile Equipment Identity (IMEI), which uniquely identifies each wireless communication device 102. Additionally, the data memory 242 may contain other identifiers (not shown) associated with additional protocols.

In one embodiment, the wireless communication device 102 contains at least two complete RF modules 204, 212 designed to operate in frequency bands designated by the communication protocols of the wireless communication device 102. The wireless communication device 102 transmits and receives signals for enabling wireless communication, such as for a cellular telephone, in a well-known manner. For example, when the wireless communication device 102 is in a “receive” mode using a first communication protocol (e.g., a CDMA protocol), the controller/processor 202 operates a first RF module 204, which couples an RF signal from a first antenna 201 to a first receiver 206 in a well known manner. The first receiver 206 receives, down-converts, and demodulates the RF signal, providing a stream of data to a first protocol decoder/encoder module 210. The first decoder/encoder module 210 decodes the received data according to the framework of the first protocol, and the controller/processor 202 outputs the data to a user in a prescribed manner. For example, audio signals are routed through an audio controller 224 to a speaker 226 or other audio device (e.g., a Bluetooth headset or earpiece). Additionally, received textual or image data is presented to the user on a display screen 222.

Likewise, when the wireless communication device 102 is in a “receive” mode using a second communication protocol (e.g., a GSM protocol), the controller/processor 202 operates a second RF module 212, which couples an RF signal from a second antenna 211 to a second receiver 214 in a well known manner. The second receiver 214 receives, down-converts, and demodulates the RF signal, providing a stream of data to a second protocol decoder/encoder module 218. The second decoder/encoder module 218 decodes the received data according to the framework of the second protocol, and the controller/processor 202 outputs the data to a user in a prescribed manner. The receive operational sequence is generally under the control of the controller/processor 202 operating in accordance with computer instructions stored in the program memory 240, in a well-known manner.

In a “transmit” mode, the controller/processor 202 (e.g., responding to a user input into a user interface 220, such as selection of one or more keys from a keypad or depression of a push-to-talk button), manages the audio controller 224 and couples electronic audio signals from an audio transducer, such as a microphone 228, to a decoder/encoder module 210, 218, where the audio signals are converted to an encoded data stream for transmission according to the appropriate communication protocol (e.g., CDMA or GSM). The controller/processor 202 enables the corresponding transmitter circuit 208, 216, which modulates the encoded data onto an RF carrier signal, couples the signal through the antenna 201, 211, and transmits the signal through the wireless communication network 100 in a manner well-known in the art.

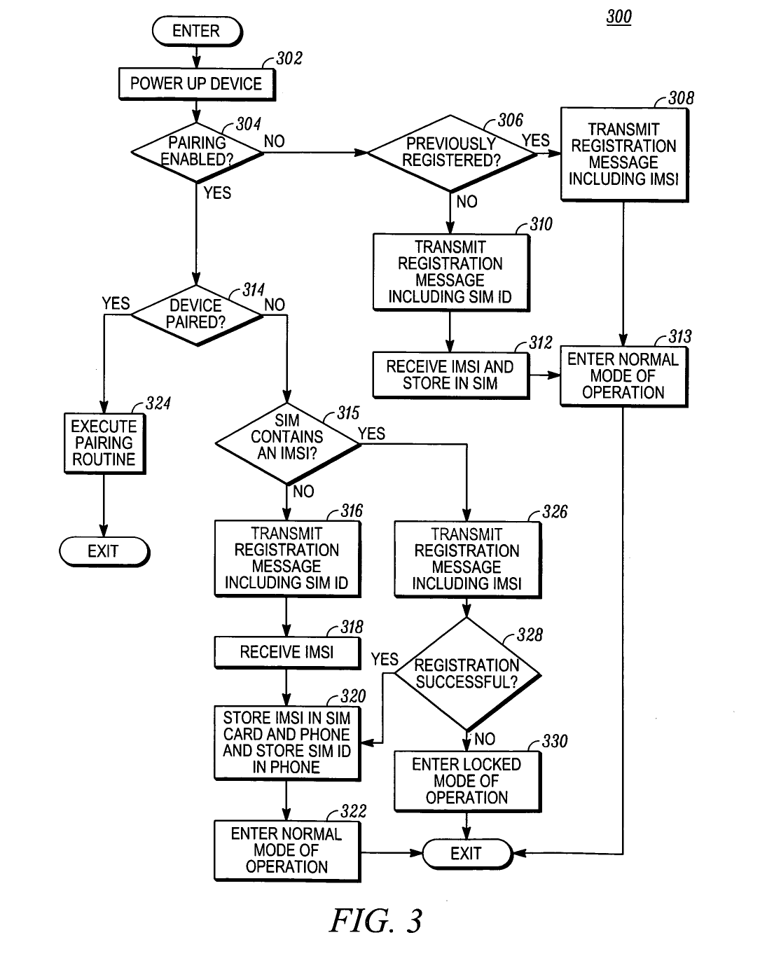

FIG. 3 illustrates an exemplary logic flow diagram 300 executed by a wireless communication device 102 to implement a method of automatically configuring the wireless communication device 102 to operate in a wireless communication system 100 in accordance with one embodiment of the present invention. The wireless communication device 102, according to one embodiment, is a cellular phone.

For purposes of discussing exemplary embodiments of the present invention, the wireless communication device 102 is identified as a cellular phone occasionally below and in FIGS. 3-5, although any portable communication device may be alternatively employed. Additionally, the removable memory device 232 is identified as a SIM or SIM card; however, other removable memory devices (e.g., a memory stick, a USB flash drive, or any other portable data storage device) may be function equally well. Further, the user ID, whether stored in the removable memory device 232 or in the data memory 242, is identified as an IMSI, although any similar ID maybe alternatively used. Still further, the memory ID (e.g., memory ID 234) for a particular removable memory device (e.g., removable memory device 232) is identified as a SIM ID to coincide with use of a SIM card as the exemplary removable storage media 232. The use herein of a SIM card, a SIM ID, and an IMSI to describe an exemplary embodiment of the present invention is solely to enhance readability of the detailed description and should not be construed as any intent to limit the scope of the present invention as set forth in the appended claims. As discussed above, any other appropriate identifiers representing a user account and a removable memory device may be used in place of the IMSI and SIM ID. Similarly, various other portable storage devices may be used in place of a SIM card.

The logic flow begins when a user of the wireless communication device 102 initiates (302) a power-up sequence for the wireless communication device 102 (e.g., by pressing a button on the user interface 220). During power up, the registration manager 241 determines (304) whether identity pairing is enabled on the wireless communication device 102.

If pairing is not enabled, the wireless communication device 102 operates according to prior art methods by linking account information to a SIM card 232 coupled to the wireless communication device 102 and allowing the wireless communication device 102 to be used with any SIM card 232 that is associated with a valid account. In this case, the registration manager 241 determines (306) whether the SIM card 232 has been previously registered. If the SIM card 232 has been previously registered, an IMSI 236 associated with the user is currently stored on the SIM card 232. Otherwise, the SIM card 232 only contains a SIM ID 234. If the SIM card 232 has been previously registered, the registration manager 241 causes the wireless communication device 102 to transmit (308) to system controller 103 (i.e., the system controller managing the portion of the wireless communication system 100 with which the SIM card 232 is used) a registration message containing the IMSI 236 stored on the SIM card 232. The wireless communication device 102 then enters (313) a normal or substantially unrestricted operating mode.

If pairing is not enabled and the SIM card 232 has never been registered, the registration manager 241 causes the wireless communication device 102 to transmit (310) to system controller 103 a registration message containing the SIM ID 234 stored on the SIM card 232. System controller 103 receives the SIM ID 234, associates the SIM ID 234 with the appropriate user account information, and transmits account information, including an IMSI, back to the wireless communication device 102. Registration is completed when the wireless communication device 102 receives (312) the IMSI 236 and stores it in the SIM card 232. The wireless communication device 102 then enters (313) a normal operating mode.

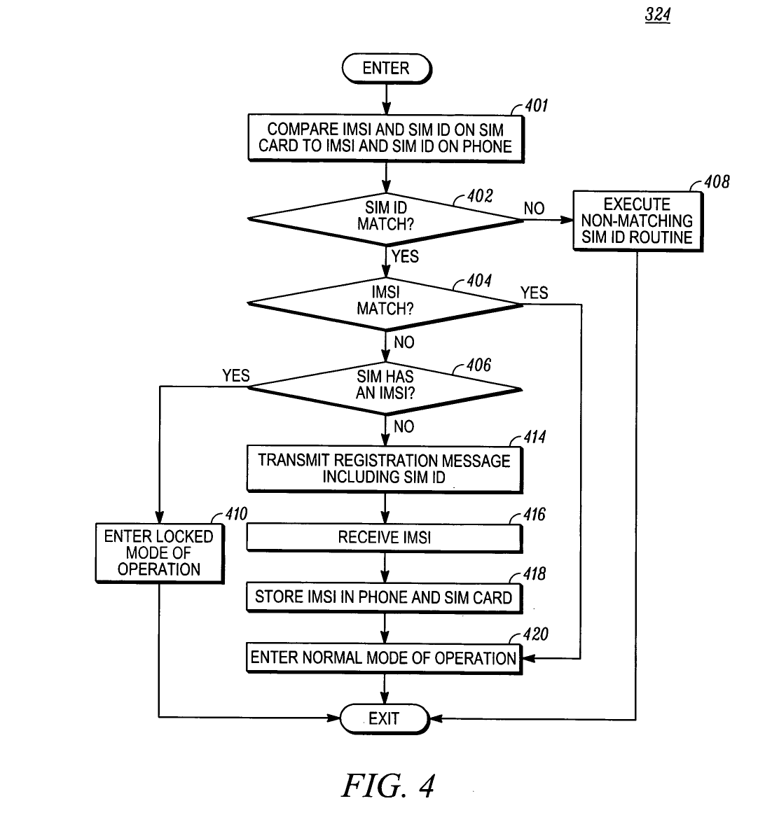

However, if pairing is enabled, the registration manager 241 determines (314) whether the wireless communication device 102 has been previously paired. If the wireless communication device 102 has been previously paired, then both a SIM ID 244 and an IMSI 246 are currently present in the data memory 242 of the wireless communication device 102. In this case, the registration manager 241 executes (324) a pairing routine, such as the pairing routine detailed below with respect to FIG. 4.

If the wireless communication device 102 has not been previously paired, the registration manager 241 determines (315) whether the SIM card 232 contains an IMSI 236. If the SIM card 232 contains an IMSI 236 (e.g., the SIM card 232 has successfully registered with system controller 103 at a prior date), the registration manager 241 causes the wireless communication device 102 to transmit (326) a registration message containing the IMSI 236 stored on the SIM card 232 to system controller 103. If the wireless communication device 102 successfully registers (328) with system controller 103 (e.g., as evidenced by receipt of an appropriate registration confirmation from system controller 103), then the registration manager 241 stores (320) the IMSI 236 in the data memory 242 of the wireless communication device 102 and in the SIM card 232, and stores the SIM ID 234 of the SIM card 232 in the data memory 242 of the wireless communication device 102. The wireless communication device 102 then enters (322) a normal operating mode. The wireless communication device 102 is now paired to the current SIM card 232 and will not function with any other SIM card without first being unpaired with the SIM card 232 and re-paired with another SIM card.

However, if the wireless communication device 102 does not successfully register with system controller 103, then the wireless communication device 102 enters (330) a locked mode of operation. During the locked mode, the wireless communication device 102 may be severely restricted in use. For example, in the locked mode, the wireless communication device 102 may be entirely inoperable or may be restricted to only permitting phone calls to certain numbers (e.g., emergency 911 calls or calls to the service provider). The wireless communication device 102, in one embodiment, may not be allowed to exit the locked mode without performing a master reset through the use of a security code obtained from the service provider.

Referring back to decision block 315, if the SIM card 232 does not contain an IMSI, then the registration manager 241 causes the wireless communication device 102 to transmit (316) a registration message containing the SIM ID 234 stored on the SIM card 232 to system controller 103. System controller 103 receives the SIM ID 234, associates the SIM ID 234 with the appropriate user account information, and transmits account information, including an IMSI, back to the wireless communication device 102. The wireless communication device 102 receives (318) the IMSI and, through operation of the registration manager 241, stores (320) the IMSI in both the SIM card 232 and the data memory 242, and stores the SIM ID 244 in the data memory 242. The wireless communication device 102 is now paired to the current SIM card 232 and enters (322) a normal operating mode.

Referring back to decision block 314, if the wireless communication device 102 has previously been paired to a SIM card 232, the registration manager 241 executes the exemplary pairing routine 324 illustrated by the logic flow diagram of FIG. 4. Pursuant to the pairing routine, the registration manager 241 compares (401) both the SIM ID 234 and the IMSI 236 stored on the SIM card 232 to the corresponding SIM ID 244 and IMSI 246 stored in the data memory 242 of the wireless communication device 102.

If the SIM IDs 234, 244 match (402), then the current SIM card 232 is the same card with which the wireless communication device 102 had previously been paired. The registration manager 241 then checks (404) to see if the IMSIs 236, 246 match. If the IMSIs match, then nothing has been changed since the last time the phone 102 was registered, so the registration manager 241 instructs the phone 102 to enter (420) a normal operating mode.

However, if the IMSIs 236, 246 do not match, then the registration manager 241 determines (406) whether the SIM card 232 contains an IMSI. If the SIM card 232 does contain an IMSI 236, then the SIM card 232 has previously been paired with a different wireless communication device, so the wireless communication device 102 enters (410) a locked operating mode as described above with respect to block 330 of FIG. 3.

Referring back to decision block 406, if the SIM card 232 does not contain an IMSI, then the SIM card 232 is most likely a brand new card that has never been registered with system controller 103. In this case, the registration manager 241 causes the wireless communication device 102 to register with the system controller 103 by transmitting (414) a registration message that includes the SIM ID 234. The wireless communication device 102 receives (416) a registration confirmation message back from system controller 103 that includes an IMSI. The registration manager 241 then stores (418) the new IMSI on the SIM card 232 and in the data memory 242, and the wireless communication device 102 proceeds to enter (420) a normal or substantially unrestricted operating mode. The new IMSI may replace the IMSI stored in the data memory 242 which was previously associated with a user account.

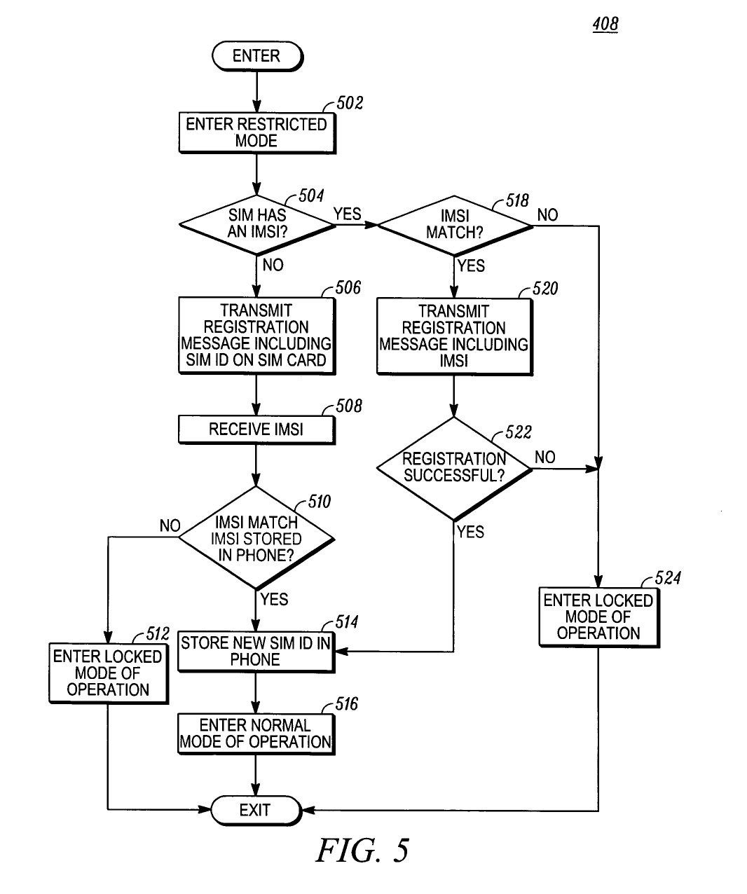

Referring back to decision block 402, if the user of the wireless communication device 102 wishes to upgrade or replace his or her SIM card 232, then the SIM IDs will not match when the new SIM card is inserted into the wireless communication device 102. If the SIM IDs do not match, then the registration manager 241 causes the wireless communication device 102 to execute (408) a non-matching SIM ID routine, which routine is illustrated in exemplary form by the logic flow of FIG. 5. To execute the exemplary non-matching SIM ID routine, the wireless communication device 102 is placed (502) in a restricted operating mode by the registration manager 241. In the restricted mode, the phone 102 may only place calls to certain numbers (e.g., emergency 911 numbers or the service provider). The registration manager 241 determines (504) whether the SIM card 232 contains an IMSI 236. If the SIM card 232 does not contain an IMSI, the registration manager 241 causes the wireless communication device 102 to transmit (506) a registration message to system controller 103 that includes the SIM ID 234 stored in the new SIM card 232. The wireless communication device 102 receives (508) a registration confirmation message back from the system controller 103 that includes an IMSI. The registration manager 241 then compares (510) the IMSI received in the registration confirmation message to the IMSI 246 stored in the data memory 242 of the phone 102. If the new IMSI is the same as the IMSI 246 previously stored in the data memory 242, the registration manager 241 re-pairs the wireless communication device 102 to the new SIM card 232 by storing (514) the SIM ID 234 of the new SIM card 232 in the data memory 242. The SIM ID 234 of the new SIM card 232 replaces the SIM ID corresponding to the SIM card previously paired to the wireless communication device 102 and stored in the data memory 242. The wireless communication device 102 then enters (516) a normal operating mode. However, if the received IMSI does not match the IMSI 246 stored in the data memory 242, the registration manager 241 places (512) the wireless communication device 102 in a locked operation mode, which may not be exited until the user enters an unlock code provided by a representative of the service provider.

Referring back to decision block 504, if the SIM card 232 does contain an IMSI 236, then the registration manager 241 determines (518) whether the IMSI 236 contained in the SIM card 232 matches the IMSI 246 stored in the data memory 242. If the IMSIs 236, 246 do not match, the registration manager 241 places (524) the wireless communication device 102 in a locked mode of operation. However, if the IMSIs 236, 246 match, then the registration manager 241 attempts to register by causing the wireless communication device 102 to transmit (520) a message to system controller 103 that includes the IMSI 236. If the registration is successful (522), the wireless communication device 102 re-pairs to the new SIM card 232 by storing (514) the new SIM ID 234 in the data memory 242. If the registration is unsuccessful (522), the wireless communication device 102 enters (524) a locked operating mode that may not be removed until the user enters a security code furnished by the service provider.

As described above, the present invention encompasses a dual-mode wireless communication device and a method of operation for automatically configuring the wireless communication device to operate in a wireless communication system. The wireless communication device includes an internal memory device and is operable with one of a plurality of removable memory devices. With the present invention, a user may automatically upgrade his or her SIM card or change account numbers without forcing the service provider to reveal an unlock code. Additionally, an embodiment of the present invention prevents components of a subscriber's account from accidentally, or intentionally, being split to allow communication access to a single account from more than one wireless communication device.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. The invention is defined solely by the appended claims including any amendments made during the pendency of this application and all equivalents of those claims as issued.

What is claimed is:

1. A method of automatically configuring a wireless communication device to operate in a wireless communication system that includes a system controller, the wireless communication device including an internal memory device and being operable with one of a plurality of removable memory devices, the internal memory device having stored therein at least a first memory identifier associated with a first removable memory device and a first user identifier associated with a user of the wireless communication device, the system controller managing access to at least part of the wireless communication system, the method comprising:
comparing the first memory identifier with a second memory identifier stored in a removable memory device coupled to the wireless communication device, the removable memory device being one of the first removable memory device and a second removable memory device;
entering a restricted operating mode in the event the first memory identifier is different than the second memory identifier;
transmitting a registration message that includes the second memory identifier to the system controller in the event that the first memory identifier is different than the second memory identifier;
receiving a registration confirmation message from the system controller, the registration confirmation message including a second user identifier associated with an expected user of the wireless communication device;
comparing the second user identifier with the first user identifier; and
ceasing operation in the restricted operating mode and entering a normal operating mode in the event that the second user identifier matches the first user identifier.

2. The method of claim 1, wherein the step of entering a restricted operating mode further comprises:
determining that the removable memory device is not the first removable memory device.

3. The method of claim 1, further comprising:
storing the second memory identifier in the internal memory in the event that the second user identifier matches the first user identifier.

4. The method of claim 3, wherein the second memory identifier is stored in place of the first memory identifier.

5. The method of claim 1, further comprising:
continuing the restricted operating mode in the event that the second user identifier is different than the first user identifier.

6. The method of claim 1, wherein the first removable memory device is a Subscriber Identity Module (SIM) and the first memory identifier is a SIM identification; and further wherein the first user identifier is an International Mobile Subscriber Identity (IMSI).

7. A method of automatically configuring a wireless communication device to operate in a wireless communication system that includes a system controller, the wireless communication device including an internal memory device and being operable with one of a plurality of removable memory devices, the internal memory device having stored therein at least a first memory identifier associated with a first removable memory device and a first user identifier associated with a user of the wireless communication device, the system controller managing access to at least part of the wireless communication system, the method comprising:
comparing the first memory identifier with a second memory identifier stored in a removable memory device coupled to the wireless communication device, the removable memory device being one of the first removable memory device and a second removable memory device;
determining the removable memory device does not contain a user identifier;
transmitting a registration message that includes the first memory identifier to the system controller;
receiving a registration confirmation message from the system controller, the registration confirmation message including a second user identifier associated with an expected user of the wireless communication device; and
storing the second user identifier in the internal memory of the wireless communication device and in the removable memory device.

8. The method of claim 7, wherein the second user identifier is stored in place of the first user identifier in the internal memory of the wireless communication device.

9. A method for automatically configuring a wireless communication device to operate in a wireless communication system that includes a system controller, the wireless communication device including an internal memory device and being operable with one of a plurality of removable memory devices, the internal memory device having stored therein at least a first memory identifier associated with a first removable memory device and a first user identifier associated with a user of the wireless communication device, the system controller managing access to at least part of the wireless communication system, the method comprising:
comparing the first memory identifier with a second memory identifier stored in a removable memory device, the removable memory device being one of the first removable memory device and a second removable memory device;
in the event that the first memory identifier does not match the second memory identifier,
entering a restricted operating mode,
determining whether the removable memory device includes a user identifier,
in the event that the removable memory device does not include a user identifier,
transmitting a registration message to the system controller, the registration message including the second memory identifier,
receiving a registration confirmation message from the system controller, the registration confirmation message including a second user identifier,
comparing the second user identifier with the first user identifier, and
ceasing the restricted operating mode and entering a normal operating mode in the event that the second user identifier matches the first user identifier; and
in the event that the first memory identifier matches the second memory identifier,
determining whether the removable memory device includes a user identifier,
in the event that the removable memory device does not include a user identifier,
transmitting the registration message to the system controller,
receiving the registration confirmation message from the system controller, and
storing the second user identifier in the internal memory and in the removable memory device.

10. The method of claim 9, further comprising:
storing the second memory identifier in the internal memory of the wireless communication device in the event that the first memory identifier does not match the second memory identifier and the second user identifier matches the first user identifier.

11. The method of claim 10, wherein the second memory identifier is stored in place of the first memory identifier in the internal memory of the wireless communication device.

12. The method of claim 9, further comprising:
in the event that the first memory identifier matches the second memory identifier and the removable memory device includes a third user identifier,
comparing the first user identifier with the third user identifier stored in the removable memory device; and
entering a locked operating mode in the event that the first user identifier does not match the third user identifier.

13. The method of claim 9, wherein the second user identifier is stored in place of the first user identifier in the internal memory of the wireless communication device in the event that the first memory identifier matches the second memory identifier, but the removable memory device does not include a user identifier.

14. The method of claim 9, further comprising:
entering a normal operating mode in the event that the first memory identifier matches the second memory identifier and the first user identifier matches the second user identifier.

15. The method of claim 9, wherein the first removable memory device is a Subscriber Identity Module (SIM) and the first memory identifier is a SIM identification; and further wherein the first user identifier is an International Mobile Subscriber Identity (IMSI).

16. A wireless communication device operable in a wireless communication system managed at least in part by a system controller, the wireless communication device comprising:
an internal memory device having stored therein at least a first memory identifier associated with a first removable memory device and a first user identifier associated with a user of the wireless communication device;
a removable storage media reader operable with one of a plurality of removable memory devices;
a processor operably coupled to the internal memory device and the removable storage media reader;
a program memory for storing operating instructions that, when executed by the processor, cause the processor to:
compare the first memory identifier with a second memory identifier stored in a removable memory device coupled to the removable storage media reader, the removable memory device being one of the first removable memory device and a second removable memory device;
enter a restricted operating mode in the event the first memory identifier is different than the second memory identifier;
compare the first user identifier to a second user identifier received from the system controller, the second user identifier being associated with an expected user of the wireless communication device; and
cease operation in the restricted operating mode and entering a normal operating mode in the event that the second user identifier matches the first user identifier;
a transmitter, operably coupled to the processor, for transmitting a registration message that includes the second memory identifier to the system controller in the event that the first memory identifier is different than the second memory identifier; and
a receiver, operably coupled to the processor, for receiving a registration confirmation message from the system controller, the registration confirmation message including the second user identifier.
